(19) United States
(12) Patent Application Publication
(10) Pub. No.: US 2003/0174142 A1
(43) Pub. Date: Sep. 18, 2003

(54) Method to produce textural gradations in vector and pixel based computer graphics applications using font based gradient characters

(76) Inventor: Jon C. Lund, Hudson, OH (US)

Correspondence Address: Jon C. Lund, 124 E. STREETSBORO ST., HUDSON, OH, 44236, US

(21) Appl. No.: 10/095,749

(22) Filed: Mar. 13, 2002

(51) Int. Cl. G09G 5/00

(52) U.S. Cl. 345/588

(57) ABSTRACT

The present invention provides a method to produce texture and gradation in vector and pixel based computer graphics programs, utilizing a group or font of gradient characters produced and controlled by said programs typographic display and printing capabilities.

### BACKGROUND OF THE INVENTION

Computer graphics and illustration is a field dominated by two separate methods of producing images on screen and in print, The first and most well known system is the pixel or raster based system. This system renders images using a grid of small adjacent squares, each square or pixel (picture element) is assigned a combination of color values depending on the imaging format. RGB (red, green, blue) for viewing on computer monitors or CMYK (cyan magenta, yellow, black) for printing in the four color printing process. The pixel based system is used to produce continuous tone or photographic images.

The graphic industry standard software application for this system is Adobe Photoshop and nearly every image seen anywhere is currently manipulated with this program.

The pixel based system works well with realistic photographs and the editing or retouching of them, but is lacking in its rendering of hard edge shapes such as lines or typography, it is also very memory inefficient and images cannot be greatly enlarged without the individual pixels becoming visible.

The second system for computer rendering images on screen or in print is known as vector, or object based system. Wherein images are displayed on screen or in print using mathematical descriptions of objects (shape) and paths (lines) utilizing a computer language known as Adobe Postscript. These objects are defined by paths that are drawn with a system of points and bezier curves. The paths are either then filled (shape) or stroked (lines) with a combination of colors and values to produce artwork.

The object based system produces illustrations with perfectly straight lines and curves with the sharpest possible edges. These illustrations can be enlarged to any size onscreen or printed at any size and still retain their sharp smooth edges. Vector based artwork is extremely memory efficient using a fraction of the memory required for a same size pixel based image. The current vector based systems detractions include: all graphics are produced with a flat and an overly perfect smooth look. No textured or hand-painted technique can be produced. It can only render a gradation using a series of gradually lighter or darker toned objects or steps. These “gradients” as they are called are awkward to apply, cannot be made transparent, and cannot be produced with any texture whatsoever. The industry standard vector based software is Adobe Illustrator.

### SUMMARY OF INVENTION

The invention provides a method to produce specifically located textured gradations in a vector or pixel based program by utilizing the programs typographic systems for displaying and printing letterforms. These textured gradients can be controlled and manipulated using the programs abilities to change the size, spacing, and placement of typography. The gradients can also be enlarged to any size and still retain their random textured appearance. which produces an effect that appears to be hand painted.

### DETAILED DESCRIPTION OF DRAWINGS

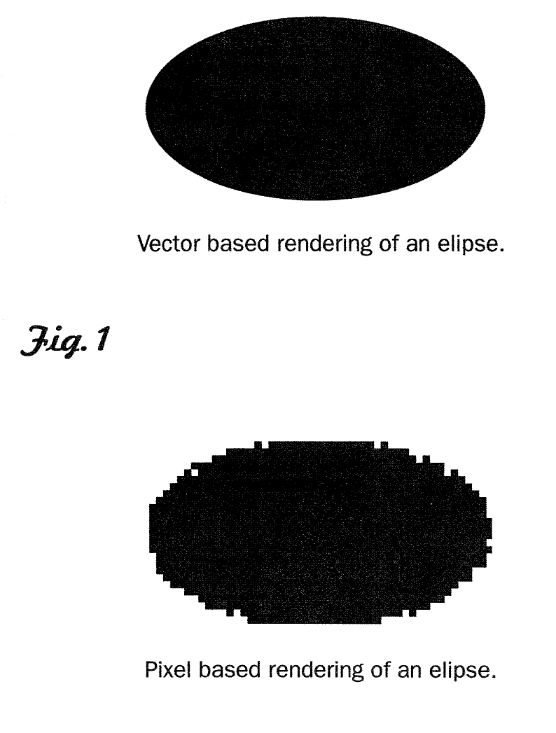

FIG. 1 is a drawing showing the different manner in which vector based illustration programs and pixel based programs render a simple ellipse shape.

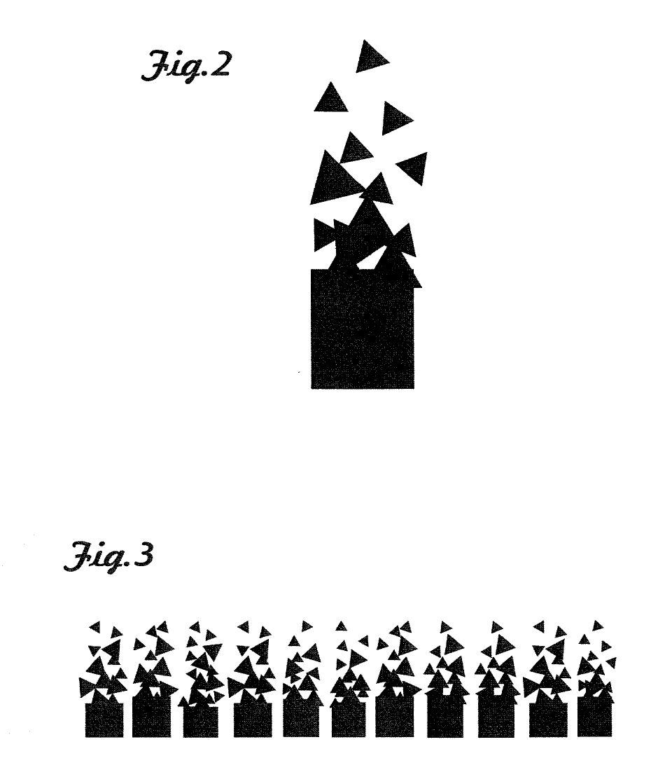

FIG. 2 is a drawing of vector based objects placed randomly into a column or gradient character.

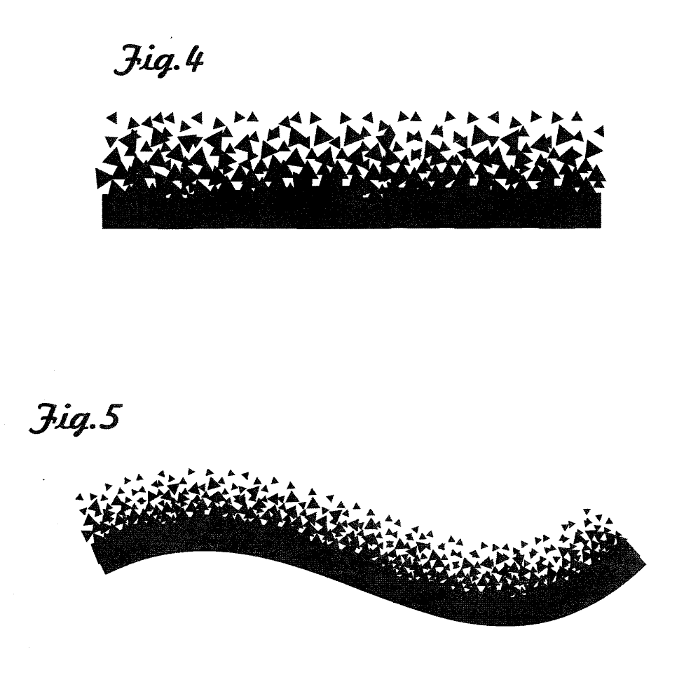

FIG. 3 illustrates a grouping of different gradient characters loosely spaced on a typeset line.

FIG. 4 shows creation of textured gradation once characters are assembled without space between.

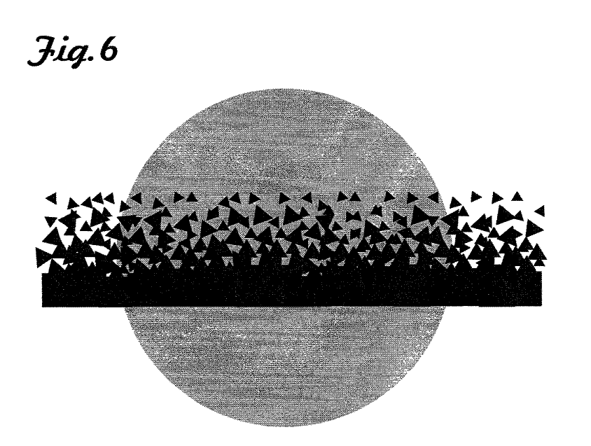

FIG. 5 shows a textured gradation following a path drawn in a vector based illustration program.

FIG. 6 demontrates how background shapes or colors are visible through foreground textural gradation.

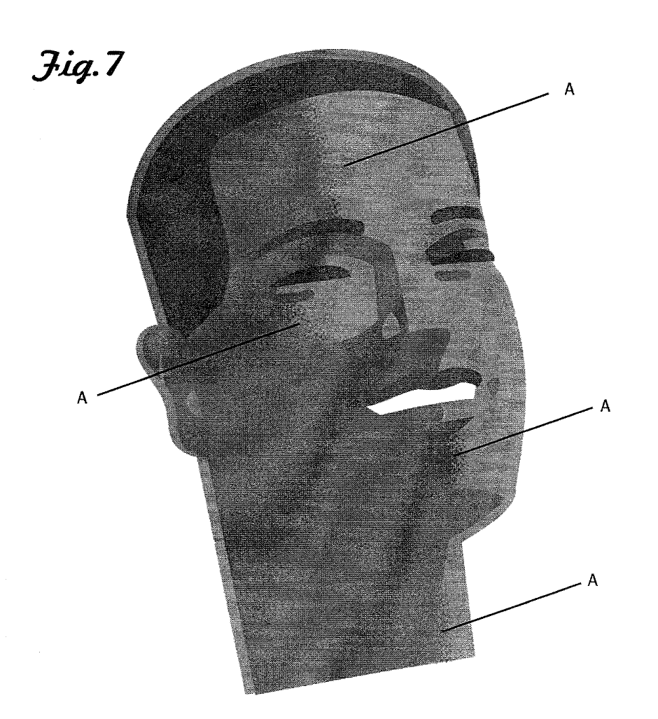

FIG. 7 Illustrates the use of the product (A) and process in a vector based illustration.

### DETAILED DESCRIPTION

The invention is a group or font of vector based illustrations. Each illustration is produced in a vector based computer graphics program and is itself a gradient arrangement of vector based objects (circles, triangles, any shape) placed in random locations in a loosely defined column and filled or painted black. The column can be straight or triangular shaped (for going around concave or convex curves). Using an industry standard typographical development program (like Macromedia's Fontographer), each illustration is then formatted to a corresponding keyboard key. It then becomes a gradient character.

The font of gradient characters are then installed on the computer's hard drive in the fonts folder just like a font of letterforms. The characters are then randomly accessed using the keyboard in any vector or pixel based computer graphics program. The program assembles the characters on a line or selected path just like it would any typography. The assembled characters produce a gradation that can be fine or coarse depending on how small or large the original random illustration objects are or how large or small the computer is told to make the font. This line of gradation can also be manipulated with any of the typographical and artistic tools in the computer graphics application.

The assembled gradations bring a hand painted textural effect to any otherwise completely hard edged illustration in a convenient, simple to apply and easy to control format.

1. I claim the process of creating by any means a library or font of gradient characters to be installed in an archive on a computer's hard drive and then having them accessed by any means and transfered individually to the environment of a vector or pixel based computer graphics program to be then assembled by any means and used to produce textural gradations of any size, shape or resolution within a vector or pixel based computer graphics program.
I claim the invention of a product and process to produce assemblies or lines of textural gradation of any resolution in any vector or pixel based computer graphics software application:
I claim the device of using illustrations of randomly placed vector based objects of any size or shape to form gradient characters of loosely formed columns of any shape. Each character being different and itself an illustration of a gradation from dark to light.
I claim the device of using industry standard typographic formatting software to create individual gradient characters with these illustrations and assign a different key on a standard keyboard for each gradient character.
I claim the device of using industry standard everyday typographic software managment tools in any computer graphics application to produce and control these textural gradations.
I claim these textural gradations can be produced to follow any path drawn in a vector based illustration program.
I claim these gradations, when used in a vector based illustration are the only way to produce a textural gradation through which an object put into an illustration's background can be seen through a textural gradation placed in the illustration's foreground.
I claim this method of producing textural gradations can produce a randomly textural or hand painted effect in any vector based computer graphics illustration program.
